(19) United States
(12) Patent Application Publication
(10) Pub. No.: US 2024/0035847 A1
(43) Pub. Date: Feb. 1, 2024

(54) PARKING STRUCTURE MAPPING SYSTEM AND METHOD

(71) Applicant: Toyota Motor Engineering & Manufacturing North America, Inc., Plano, TX (US)

(72) Inventors: Takamasa Higuchi, Mountain View, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/873,354

(22) Filed: Jul. 26, 2022

(51) Int. Cl. G01C 21/00

(52) U.S. Cl. CPC G01C 21/3841; G01C 21/383; G01C 21/3852

(57) ABSTRACT

A system includes a processor and a memory in communication with the processor. The memory has instructions that, when executed by the processor, cause the processor to generate, based on an image of a roof of a multi-level parking structure, a roof map having at least one road segment and at least one parking space of the roof. The instructions further cause the processor to predict, based on the roof map, a lower level map having at least one road segment and at least one parking space of a lower level of the parking structure.

### TECHNICAL FIELD

The subject matter described herein relates, in general, to systems and methods for mapping a parking structure and, more specifically, to mapping a multi-level parking structure without the use of high-cost LIDAR sensors.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Some electronic maps that contain information regarding the location of parking structures do not contain information regarding the specific layout of a particular parking structure. As such, while an electronic map may provide the location of the parking structure, the electronic map may not have information regarding the location of individual parking spaces, access lanes, and exit/entrances to the parking structure.

In more recent developments, some electronic maps have more detailed information regarding parking structures, including the location of parking spaces, access lanes, and/or exit/entrances to the parking structure. Generally, this more detailed information is generated by utilizing sensor information collected from a vehicle that has operated within the parking structure. Moreover, when operating within the parking structure, the vehicle can collect sensor information detailing the vehicle's trajectory and location using algorithms to process distance, direction, and elevation changes made during satellite signal interruption (i.e., dead-reckoning). Additionally, sensor information collected from cameras, LIDAR sensors, and other sensors can be utilized to determine the location of parking spaces, access lanes, exit/entrances, and other features of the parking structure. This collected information can then be processed to determine specific features regarding the parking structure, such as the location of parking spaces, access lanes, exit/entrances, and the like

However, these systems have drawbacks. First, collecting sensor information from a vehicle and processing this information can be time-consuming and expensive. Additionally, dead-reckoning systems may accordingly be useful for locating a vehicle in above or below-ground parking structures and in tunnels where global navigation satellite system (GNSS) signals may be blocked. However, dead-reckoning systems may produce cumulative errors resulting in inaccurate estimations of a vehicle's location.

### SUMMARY

This section generally summarizes the disclosure and is not a comprehensive explanation of its full scope or all its features.

In one embodiment, a system for mapping a multi-level parking structure is disclosed. The system includes a processor and a memory in communication with the processor. The memory has instructions that, when executed by the processor, cause the processor to generate, based on an image of a roof of a multi-level parking structure, a roof map having at least one road segment and at least one parking space of the roof. The instructions further cause the processor to predict, based on the roof map, a lower level map having at least one road segment and at least one parking space of the lower level of the parking structure.

In another embodiment, a method of mapping a multi-level parking structure is disclosed. The method includes the step of generating, based on an image of a roof of a multi-level parking structure, a roof map having at least one road segment and at least one parking space of the roof. The method also includes predicting, based on the roof map, a lower level map having at least one road segment and at least one parking space of the lower level of the parking structure.

In yet another embodiment, a non-transitory computer-readable medium having instructions that, when executed by a processor, cause the processor to map a multi-level parking structure is disclosed. The instructions cause the processor to generate, based on an image of a roof of a multi-level parking structure, a roof map having at least one road segment and at least one parking space of the roof. The instructions further cause the processor to predict, based on the roof map, a lower level map having at least one road segment and at least one parking space of the lower level of the parking structure.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a parking structure mapping system, an imaging device, and a vehicle in an example environment in which the parking structure mapping system may operate;

FIG. 2 illustrates an example of the parking structure mapping system;

FIG. 3 illustrates an example of the vehicle of FIG. 1;

FIG. 4 illustrates an example of the imaging device of FIG. 1;

FIG. 5A illustrates an example of an image of a roof of a multi-level parking structure captured by the imaging device;

FIG. 5B illustrates an example of a roof map generated based on the image of the roof and a lower level map generated based on the roof map;

FIG. 6A illustrates an example of a lower level traveled vehicle road segment and a parking space used by a vehicle traveling through the multi-level parking structure;

FIG. 6B illustrates an example of an updated lower level map showing the traveled vehicle road segment and the parking space utilized by the vehicle;

FIG. 7 illustrates an example of a vehicle traveling between two levels of the multi-level parking structure;

FIG. 8 illustrates an example of a method of mapping a multi-level parking structure including an optional step to update a lower level map;

FIG. 9A illustrates a first example of the optional step of updating a lower level map;

FIG. 9B illustrates a second example of the optional step of updating a lower level map;

FIG. 9C illustrates a third example of the optional step of updating a lower level map; and

FIG. 9D illustrates a fourth example of the optional step of updating a lower level map.

### DETAILED DESCRIPTION

Described are systems and methods for mapping a multi-level parking structure without using high-cost vehicular sensor systems such as LIDAR. An image of a roof of a multi-level parking structure may be obtained using an imaging device such as a drone, satellite, or aircraft. A roof map may be generated using the image, including georeferenced data, including geographical coordinates of parking spaces and/or road segments on the roof. Based on the roof map, a map of a lower level of the multi-level parking structure may be predicted by duplicating the roof map. Sensor data from one or more vehicles traveling through the multi-level parking structure may be used to determine a trajectory of the vehicle(s), which may then be used to update the lower level map. The sensor data can include data from low-cost vehicle sensors, including accelerometers, gyroscopes, and/or steering wheel angle sensors. The sensor data can also be used to determine a number of lower levels of the multi-level parking structure.

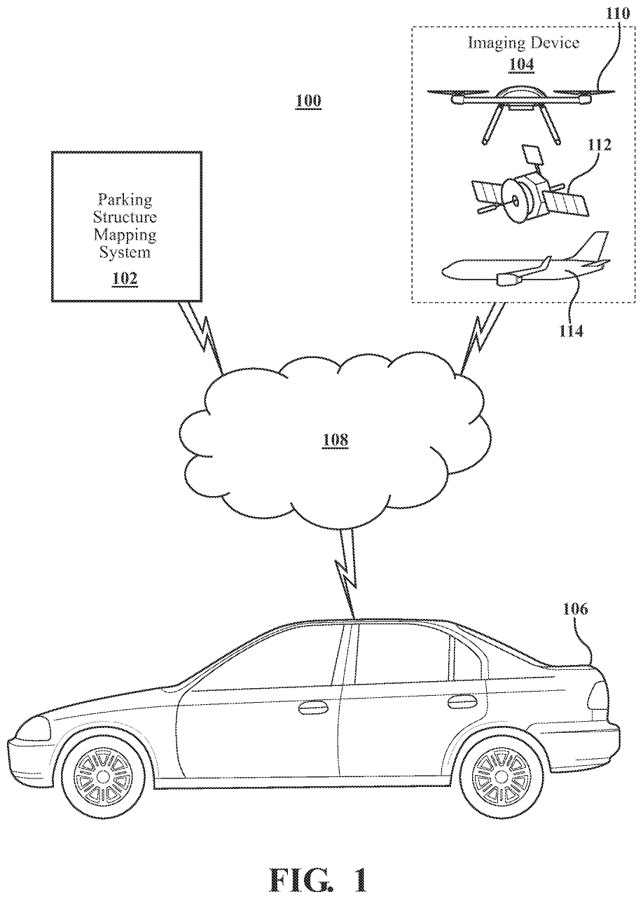

Referring to FIG. 1, an example environment 100 in which a parking structure mapping system 102 may operate is shown. The environment 100 may include the parking structure mapping system 102, one or more imaging devices 104, and one or more vehicles 106. For brevity, this description follows with respect to one imaging device 104 and one vehicle 106. However, it should be understood that the description applies to multiple imaging devices 104 and multiple vehicles 106. The parking structure mapping system 102, the imaging device 104, and the vehicle 106 may be communicatively connected in any suitable manner. For example, the parking structure mapping system 102, the imaging device 104, and the vehicle 106 may be communicatively connected through a cloud 108.

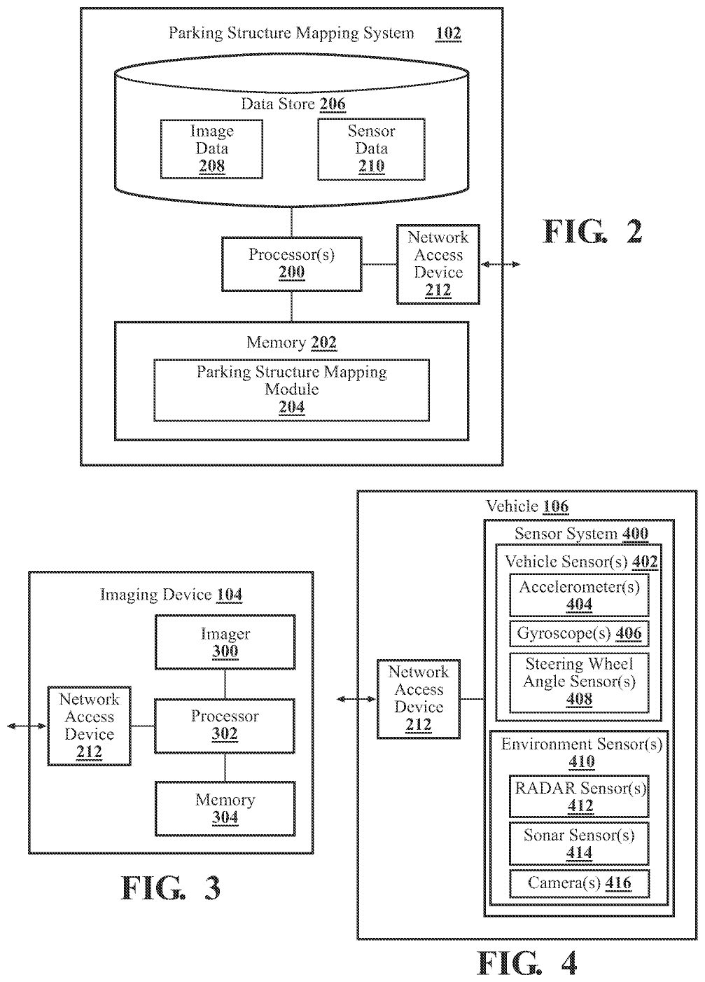

Referring to FIG. 2, one embodiment of the parking structure mapping system 102 is illustrated. As shown, the parking structure mapping system 102 includes one or more processors 200. Accordingly, the processor(s) 200 may be a part of the parking structure mapping system 102, or the parking structure mapping system 102 may access the processor(s) 200 through a data bus or another communication path. In one or more embodiments, the processor(s) 200 are an application-specific integrated circuit configured to implement functions associated with one or more modules of the parking structure mapping system 102. In general, the processor(s) 200 are one or more electronic processors such as one or more microprocessors that can perform various functions as described herein. In one embodiment, the parking structure mapping system 102 includes a memory 202 that stores the module(s), for example, a parking structure mapping module 204. The memory 202 is a random-access memory (RAM), read-only memory (ROM), a hard disk drive, a flash memory, or other suitable memory for storing the module(s). The module(s) are, for example, computer-readable instructions that, when executed by the processor(s) 200, cause the processor(s) 200 to perform the various functions disclosed herein.

The parking structure mapping system 102 may also include a data store 206. The data store 206 is, in one embodiment, an electronic data structure such as a database that is stored in the memory 202 or another memory and that is configured with routines that can be executed by the processor(s) 200 for analyzing stored data, providing stored data, organizing stored data, and so on. Thus, in one embodiment, the data store 206 stores data used by the module(s), for example, the parking structure mapping module 204, in executing various functions. In one embodiment, the data store 206 includes image data 208 and sensor data 210, along with, for example, other information that may be used by the parking structure mapping module 204. The parking structure mapping system 102 may also include a network access device 212. The network access device 212 may include any port or device capable of communicating via wired or wireless interfaces such as Wi-Fi, Bluetooth, a cellular protocol, vehicle-to-vehicle communications, or the like. For example, the network access device 212 may communicate with the cloud 108. Accordingly, the network access device 212 may communicate with the imaging device 104 and/or the vehicle 106 using the cloud 108. The network access device 212 may further communicate with a remote server, for example, via the cloud 108.

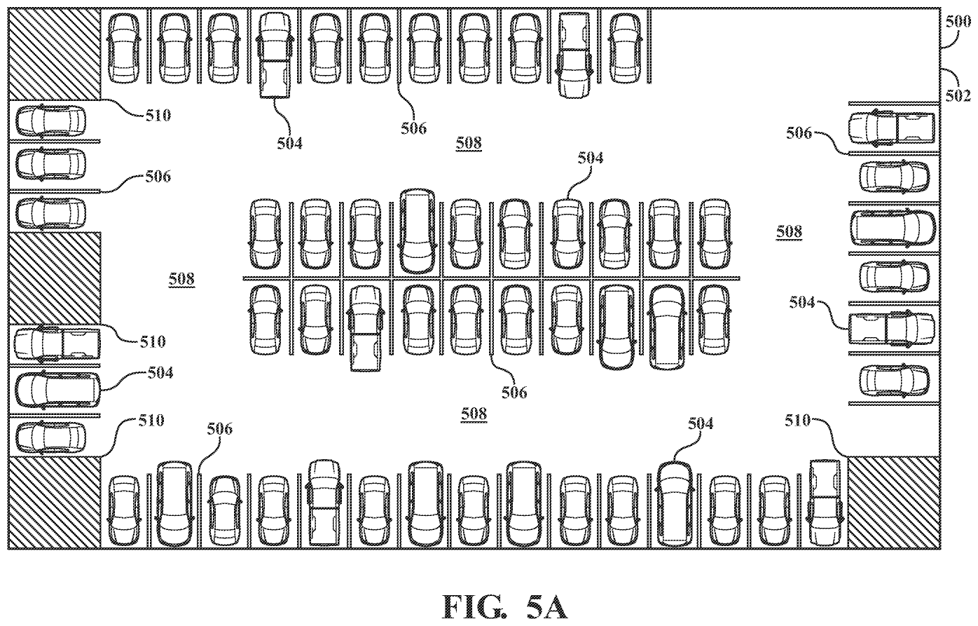

Referring to FIG. 3, the imaging device 104 may also include a network access device 212. The network access device 212 of the vehicle 106 may be the network access device 212 described above or an additional network access device. The imaging device 104 can be any type of device suitable for capturing an image 500. For example, the imaging device 104 can be a drone 110, a satellite 112, and/or an aircraft 114 (FIG. 1). The imaging device 104 may include an imager 300, for example, one or more cameras. The imaging device 104 may also include a memory 304 suitable for storing one or more images (e.g., image data 208) captured by the imager 300, and a processor 302 suitable for communicating the images (e.g., image data 208) to the network access device 212.

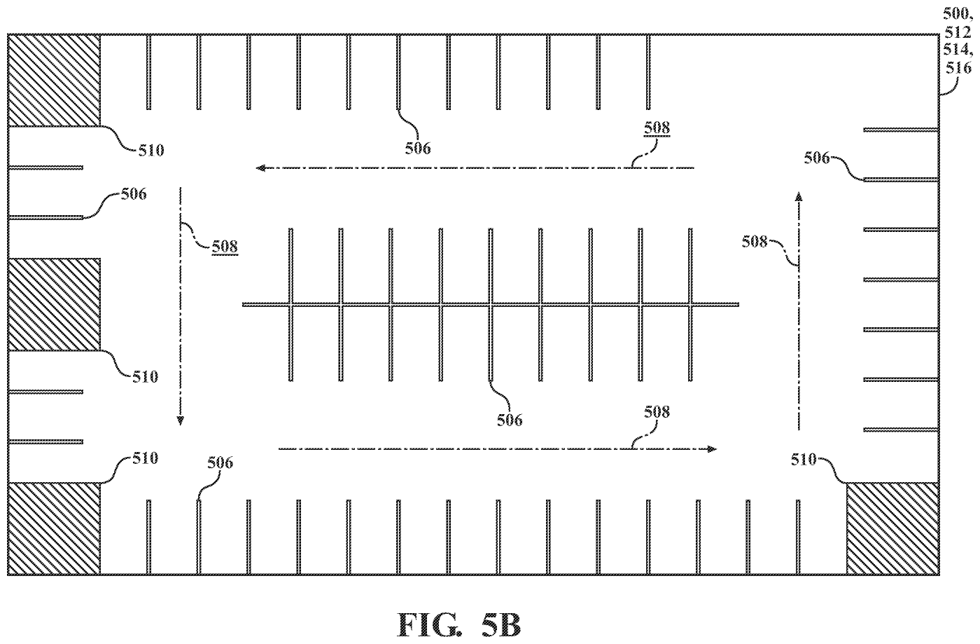

Referring to FIG. 4, the vehicle 106 may also include a network access device 212. The network access device 212 of the vehicle 106 may be the network access device 212 described above or an additional network access device. The vehicle 106 may also include, among other components typical of vehicles, a sensor system 400. The sensor system 400 can include one or more sensors. “Sensor” means any device, component, and/or system that can detect and/or sense something. The one or more sensors can be configured to detect and/or sense in real-time. As used herein, the term “real-time” means a level of processing responsiveness that a user or system senses as sufficiently immediate for a particular process or determination to be made or that enables the processor(s) 200 to keep up with some external process. In arrangements in which the sensor system 400 includes a plurality of sensors, the sensors can work independently from each other. Alternatively, two or more of the sensors can work in combination with each other. In such a case, the two or more sensors can form a sensor network. The sensor system 400 and/or the one or more sensors can be operatively connected to the processor(s) 200, the data store 206, and/or another element of the vehicle 106. The sensor system 400 can acquire data of at least a portion of the external environment of the vehicle 106. The sensor system 400 can include any suitable type of sensor. Various examples of different types of sensors will be described herein. However, it will be understood that the embodiments are not limited to the particular sensors described.

The sensor system 400 can include one or more vehicle sensors 402. The vehicle sensor(s) 402 can detect, determine, and/or sense information about the vehicle 106 itself. In one or more arrangements, the vehicle sensor(s) 402 can be configured to detect, and/or sense position and orientation changes of the vehicle 106, such as, for example, based on inertial acceleration. In one or more arrangements, the vehicle sensor(s) 402 can include one or more accelerometers 404, one or more gyroscopes 406, and one or more steering wheel angle sensors 408. The vehicle sensor(s) 402 can also include any other suitable type of sensor, for example, an inertial measurement unit (IMU), a dead-reckoning system, a global navigation satellite system (GNSS), a global positioning system (GPS), a navigation system, and/or other suitable sensors. The vehicle sensor(s) 402 can be configured to detect, and/or sense one or more characteristics of the vehicle 106. In one or more arrangements, the vehicle sensor(s) 402 can also include a speedometer to determine the current speed of the vehicle 106.

Alternatively, or in addition, the sensor system 400 can include one or more environment sensors 410 configured to acquire and/or sense driving environment data. “Driving environment data” includes data or information about the external environment in which a vehicle 106 is located or one or more portions thereof. For example, the environment sensor(s) 410 can be configured to detect, quantify and/or sense obstacles in at least a portion of the external environment of the vehicle 106 and/or information/data about such obstacles. Such obstacles may be stationary objects and/or dynamic objects. The environment sensor(s) 410 can be configured to detect, measure, quantify and/or sense other things in the external environment of the vehicle 106, such as, for example, lane markers, signs, traffic lights, traffic signs, lane lines, crosswalks, curbs proximate the vehicle 106, off-road objects, etc.

Various examples of sensors of the sensor system 400 will be described herein. The example sensors may be part of the environment sensor(s) 410 and/or the vehicle sensor(s) 402. However, it will be understood that the embodiments are not limited to the particular sensors described. As an example, in one or more arrangements, the sensor system 400 can include one or more RADAR sensors 412, one or more sonar sensors 414, and/or one or more cameras 416. In one or more arrangements, the camera(s) 416 can be high dynamic range (HDR) cameras or infrared (IR) cameras. The environment sensor(s) 410 can also include any other suitable type of sensor.

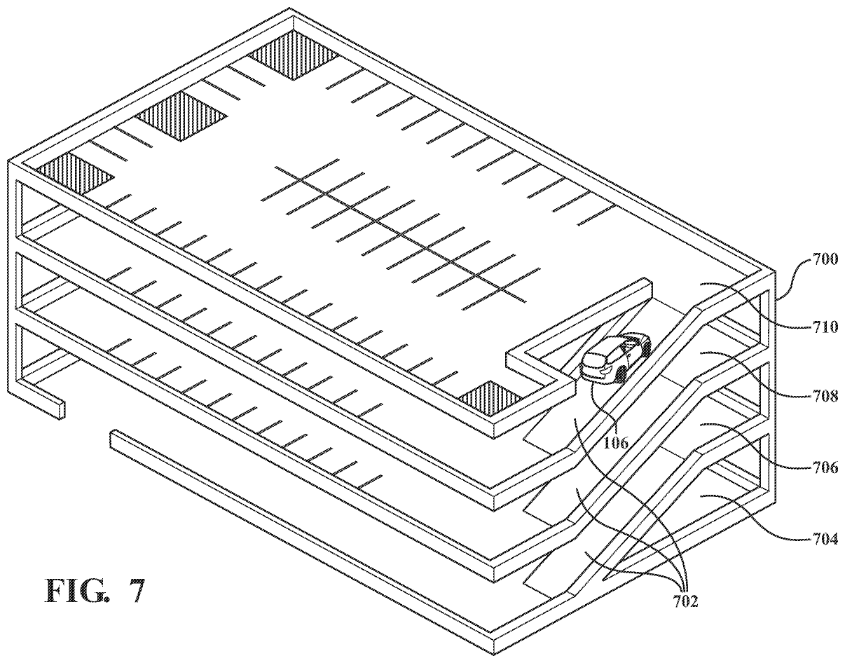

Referring again to FIG. 2, in one embodiment, the parking structure mapping module 204 generally includes instructions that function to control the processor(s) 200 to generate a map of a multi-level parking structure 700. An example of a multi-level parking structure 700 is shown in FIG. 7. The multi-level parking structure 700 may be any kind of multi-level parking structure, for example, an above-ground parking structure or a below-ground parking structure. The parking structure mapping module 204 may include instructions that function to control the processor(s) 200m to generate a map of the multi-level parking structure 700 using one or more images (e.g., the image data 208) acquired by the imaging device 104 and using the sensor data 210 acquired by the sensor system 400 of the vehicle 106. Furthermore, the map may be generated without using data from high-cost sensors such as LIDAR sensors.

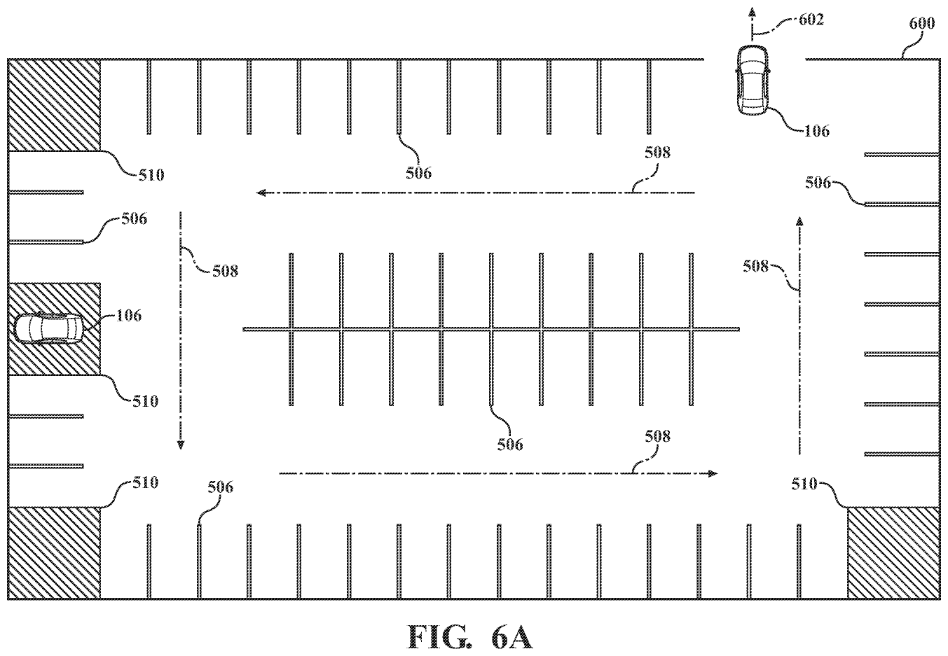

Referring to FIG. 5A, the parking structure mapping module 204 may include instructions that function to control the processor(s) 200 to receive, from the imaging device 104, an image 500 of a roof 502 of the multi-level parking structure 700. The image 500 may show one or more vehicles 504 parked on the roof 502, one or more parking spaces 506 of the roof 502, one or more road segments 508 of the roof 502, one or more no-parking zones 510 of the roof 502, and/or any other features of the roof 502. The image 500 may be georeferenced (e.g., the image 500 may include geographical coordinates, latitude, longitude, and/or altitude information embedded in each pixel). More specifically, one or more of the parking spaces 506, the road segments 508, and/or the no-parking zones 510 may be georeferenced and may include geographical coordinates, latitude, longitude, and/or altitude information.

Referring to FIG. 5B, the parking structure mapping module 204 may include instructions that function to control the processor(s) 200 to generate a roof map 512 based on the image 500 of the roof 502. The parking structure mapping module 204 may also include instructions that function to control the processor(s) 200 to identify the parking space(s) 506, the road segment(s) 508, and/or the no-parking zone(s) 510 located on the roof 502 and add the parking space(s) 506, the road segment(s) 508, and/or the no-parking zone(s) 510 to the roof map 512. This may include identifying the geographical coordinates of the parking space(s) 506, the road segment(s) 508, and/or the no-parking zone(s) 510. Accordingly, the roof map 512 may include the parking space(s) 506, the road segment(s) 508, and/or the no-parking zone(s) 510.

The parking structure mapping module 204 may further include instructions that function to control the processor(s) 200 to predict, based on the roof map 512, a lower level map 514 of the multi-level parking structure 700. This may be done by duplicating the roof map 512. Accordingly, FIG. 5B may also depict a lower level map 514, which is a copy of the roof map 512. More specifically, the lower level map 514 may include all of the parking space(s) 506, all of the road segment(s) 508, and all of the no-parking zone(s) 510 of the roof map 512.

The lower level map 514 may be an initial lower level map 516 because the lower level map 514 may not be completely accurate when it is a copy of the roof map 512. For example, one or more of the lower levels of the multi-level parking structure 700 may have a slightly different topology from the roof map 512. For example, one or more of the lower levels may include support structures 610 used to support the roof 502 and/or other levels of the multi-level parking structure 700, and the roof 502 would not include these support structures 610. Accordingly, the parking structure mapping module 204 may include instructions that function to control the processor(s) 200 to update the initial lower level map 516 so that it is more accurate. This may be done by gathering information from one or more vehicles traveling through the multi-level parking structure 700, for example, information about the trajectory of a vehicle 106 traveling through the multi-level parking structure 700. For brevity, this description will follow with reference to one vehicle 106 traveling through the multi-level parking structure 700. The vehicle 106 may be the vehicle 106 of FIGS. 1 and 4.

Accordingly, the parking structure mapping module 204 may include instructions that function to control the processor(s) to receive, from the vehicle 106, sensor data 210 regarding a trajectory of the vehicle 106. More specifically, the parking structure mapping module 204 may include instructions that function to control the processor(s) 200 to receive the sensor data 210 (e.g., data from the vehicle sensor(s) 402 and/or the environment sensor(s) 410) and determine a trajectory of the vehicle 106 through the lower level based on the sensor data 210. The trajectory of the vehicle 106 may be used to update the lower level map 514.

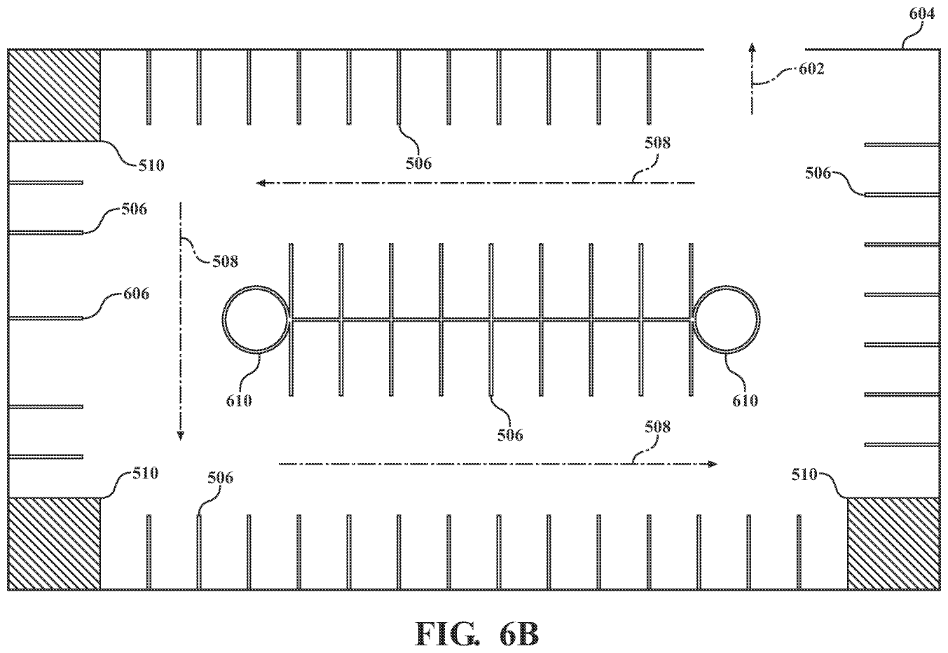

For example, FIG. 6A depicts two examples of a vehicle 106 traveling through a lower level 600 of the multi-level parking structure 700. In one example, the vehicle 106 may be traveling in a direction exiting the multi-level parking structure 700. For example, the vehicle 106 may be exiting the multi-level parking structure 700 on a ground level of the multi-level parking structure 700. The lower level map 514 may be updated to include this exit. Accordingly, the parking structure mapping module 204 may include instructions that function to control the processor(s) 200 to determine a traveled vehicle road segment 602 based on the sensor data 210 (e.g., based on the trajectory of the vehicle 106) and update the lower level map 514 using the traveled vehicle road segment 602. The traveled vehicle road segment 602 may be a road segment the vehicle 106 has traveled. For example, the traveled vehicle 106 road segment may be a road segment leading out of the multi-level parking structure 700 (e.g., an exit from the multi-level parking structure 700). Accordingly, the parking structure mapping module 204 may include instructions that function to control the processor(s) 200 to update the lower level map 514 to add the exit. Referring now to FIG. 6B, an updated lower level map 604 is shown. The updated lower level map 604 may include the traveled vehicle road segment 602.

With reference again to FIG. 6A, in another example, the vehicle 106 may be parked at a location corresponding to a no-parking zone 510 on the roof map 512 (e.g., the initial lower level map 516). This may be because the no-parking zone 510 on the roof 502 may include a light post or another structure preventing a vehicle from parking at that location, but the lower level 600 may not include such structures. The lower level map 514 may be updated to include the new parking space 606. Accordingly, the parking structure mapping module 204 may include instructions that function to control the processor(s) 200 to determine that the vehicle 106 is parked at a location on the lower level 600 that does not correspond to a parking space 506 of the roof map 512 and update the lower level map 514 to define a new parking space 606 at the location at which the vehicle 106 is parked. Referring again to FIG. 6B, the new parking space 606 is shown on the updated lower level map 604.

With reference again to FIG. 6A, in another example, though not shown, the vehicle 106 may, in some instances, not use one or more parking spaces 506 shown on the initial lower level map 516. This may be because there are parking space(s) 506 on the roof 502 that might not be accessible on one or more of the lower levels. For example, a lower level 600 may include support structures 610 such as columns supporting the roof 502 level, and the vehicle 106 may not be able to park in those areas. The lower level map 514 may be updated to remove those parking space(s) 506. Accordingly, the parking structure mapping module 204 may include instructions that function to control the processor(s) 200 to determine that one or more parking spaces 506 of the roof map 512 are not used by the vehicle 106 and update the lower level map 514 to delete the parking space(s) 506. Referring again to FIG. 6B, the updated lower level map 604 shows representations of support structures 610 in place of the deleted parking spaces 506.

Referring again to FIG. 6A, in another example, though not shown, the vehicle 106 may, in some instances, not use one or more road segments 508 shown on the initial lower level map 516. This may be because there are road segment(s) 508 on the roof 502 that might not be accessible on one or more of the lower levels. For example, one or more road segments 508 on a lower level 600 may be under construction, and the vehicle 106 may not be able to use those road segment(s) 508. The lower level map 514 may be updated to remove those road segment(s) 508. Accordingly, the parking structure mapping module 204 may include instructions that function to control the processor(s) 200 to determine that one or more road segments 508 of the roof map 512 are not used by the vehicle 106 and update the lower level map 514 to delete the road segment(s) 508. Referring yet again to FIG. 6B, the updated lower level map 604 may reflect a deleted road segment.

In some embodiments, the above-described map updates may need to be made to different lower levels of the multi-level parking structure 700. For example, with reference to FIG. 7, the multi-level parking structure 700 may have four levels, and a first level 704 may be updated to depict an exit, while a second level 706 and a third level 708 may be updated to depict support structures 610. Accordingly, in some embodiments, it may be beneficial for the parking structure mapping module 204 to determine the number of levels of the multi-level parking structure 700. Thus, the parking structure mapping module 204 may include instructions that function to control the processor(s) 200 to determine a number of lower levels of the multi-level parking structure 700 based on the sensor data 210 (e.g., based on the trajectory of the vehicle 106). For example, the sensor data 210 may indicate that the vehicle 106 traveled on a ramp 702 3 times. Accordingly, the parking structure mapping module 204 may include instructions that function to control the processor(s) 200 to determine that the multi-level parking structure 700 has 4 total levels: a first level 704 (e.g., ground level), a second level 706, a third level 708, and a fourth level 710 (e.g., roof 502). The parking structure mapping module 204 may also include instructions that function to control the processor(s) 200 to predict lower level maps for each of the lower levels of the multi-level parking structure 700. This may be done as described above by duplicating the roof map 512 and updating the lower level maps 514 using sensor data 210 regarding a trajectory of a vehicle 106 through the multi-level parking structure 700.

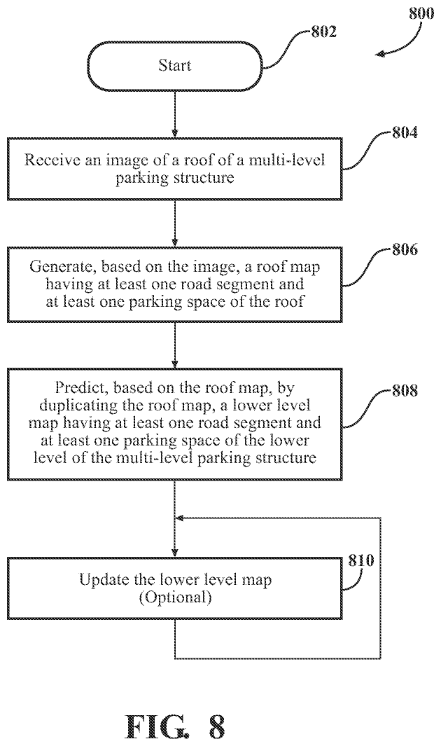

Referring now to FIG. 8, an exemplary method 800 for mapping a multi-level parking structure 700 is shown. The method 800 will be described from the viewpoint of the parking structure mapping system 102 of FIGS. 1 and 2. However, it should be understood that this is just one example of implementing the method 800. Moreover, while the method 800 is discussed in combination with the parking structure mapping system 102, it should be appreciated that the method 800 is not limited to being implemented within the parking structure mapping system 102 but is instead one example of a system that may implement the method 800.

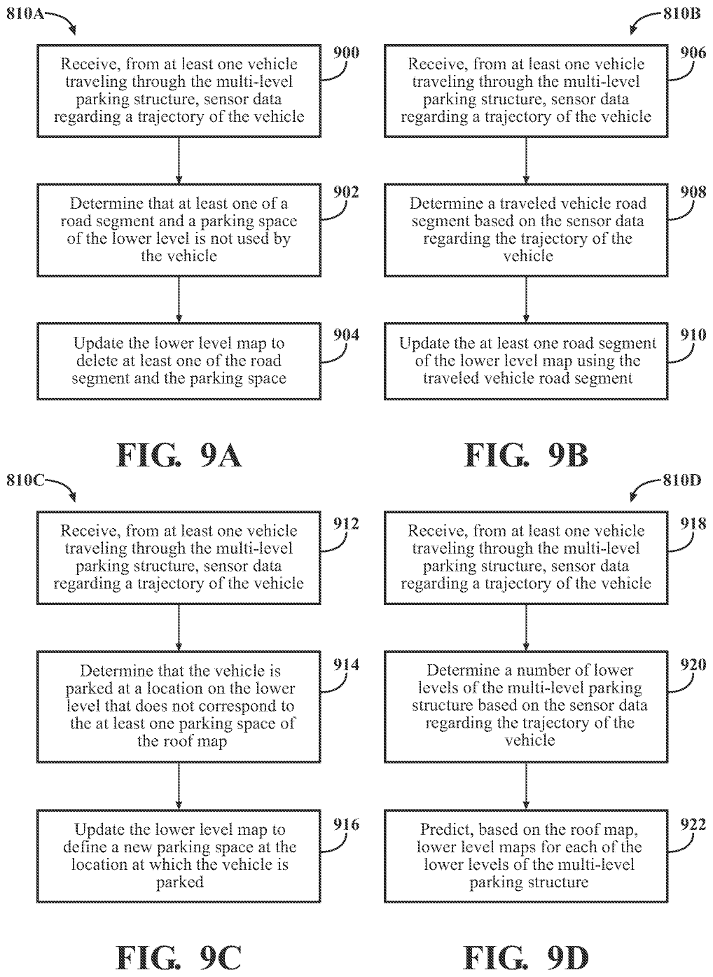

The method may begin at step 802. In step 804, an image 500 of a roof 502 of a multi-level parking structure 700 may be received. The image 500 may be received by the processor(s) 200 of the parking structure mapping system 102. The image 500 of the roof 502 may be captured by an imaging device 104 such as a drone 110, a satellite 112, or an aircraft 114. In step 806, a roof map 512 having at least one parking space 506 and at least one road segment 508 of the roof 502 may be generated based on the image 500. For example, the processor(s) 200 may generate, based on the image 500, a roof map 512 having at least one parking space 506 and at least one road segment 508 of the roof 502. In step 808, a lower level map 514 may be predicted based on the roof map 512 by duplicating the roof map 512. For example, the processor may predict, based on the roof map 512, by duplicating the roof map 512, a lower level map 514. The lower level map 514 may have at least one parking space 506 and at least one road segment 508 of the lower level 600. Optionally, in step 810, the lower level map 514 may be updated. For example, the processor(s) 200 may update the lower level map 514. Various examples of step 810 (step 810A, step 810B, step 810C, and step 810D) are illustrated in FIGS. 9A-9D and described in further detail below. It should be understood that steps 810A-D may all be performed in the method 800, or the method 800 may include one or only some of steps 810A-D.

Step 810A is shown in FIG. 9A. Step 810A may begin in step 900, in which sensor data 210 regarding a trajectory of a vehicle 106 traveling through the multi-level parking structure 700 may be received. For example, the sensor data 210 may be received by the processor(s) 200. In step 902, it may be determined that a parking space 506 and/or a road segment 508 of the lower level 600 is not used by the vehicle 106. For example, the processor(s) 200 may determine that a parking space 506 and/or a road segment 508 of the lower level 600 is not used by the vehicle 106. In some instances, a parking space 506 may not be used by the vehicle 106 because the lower level 600 includes support structures 610 in the same place where the roof 502 includes parking spaces 506. In some instances, a road segment 508 of the lower level 600 may not be used by the vehicle 106 because it is under construction. In step 904, the lower level map 514 may be updated to delete the parking space 506 and/or the road segment 508. For example, the processor(s) 200 may update the lower level map 514 to delete the parking space 506 and/or the road segment 508 that is not used by the vehicle 106.

Step 810B is shown in FIG. 9B. Step 810B may begin in step 906, in which sensor data 210 regarding a trajectory of a vehicle 106 traveling through the multi-level parking structure 700 may be received. For example, the sensor data 210 may be received by the processor(s) 200. In step 908, a traveled vehicle road segment 602 may be determined based on the sensor data 210 regarding the trajectory of the vehicle 106. For example, the processor(s) 200 may determine, based on the sensor data 210, a traveled vehicle road segment 602. The traveled vehicle road segment 602 may be a road segment 508 the vehicle 106 has traveled, for example, an exit from a ground level of the multi-level parking structure 700. In step 910, the lower level map 514 may be updated using the traveled vehicle road segment 602. For example, the processor(s) 200 may update the lower level map 514 to add the traveled vehicle road segment 602, for example, the lower level map 514 may be a ground level map and the ground level map may be updated to include an exit that the vehicle 106 has traveled.

Step 810C is shown in FIG. 9C. Step 810C may begin in step 912, in which sensor data 210 regarding a trajectory of a vehicle 106 traveling through the multi-level parking structure 700 may be received. For example, the sensor data 210 may be received by the processor(s) 200. In step 914, it may be determined that the vehicle 106 is parked at a location on the lower level 600 that does not correspond to a parking space of the roof map 512. For example, the processor(s) 200 may determine that the vehicle 106 is parked at a location on the lower level 600 that corresponds to a no-parking zone 510 on the roof 502. In step 916, the lower level map 514 may be updated to define a new parking space 606 at the location at which the vehicle 106 is parked. For example, the processor(s) 200 may update the lower level map 514 to define a new parking space 606 at the location that corresponds to the no-parking zone 510 on the roof 502.

Step 810D is shown in FIG. 9D. Step 810D may begin in step 918, in which sensor data 210 regarding a trajectory of a vehicle 106 traveling through the multi-level parking structure 700 may be received. For example, the sensor data 210 may be received by the processor(s) 200. In step 920, a number of lower levels of the multi-level parking structure 700 may be determined based on the sensor data 210 regarding the trajectory of the vehicle 106. For example, the processor(s) 200 may determine that the number of lower levels of the multi-level parking structure 700 is 3 (e.g., a first level 704 (e.g., a ground level), a second level 706, a third level 708, and a fourth level 710 (e.g., a roof 502)) based on the sensor data 210. This may be done by determining how many times the vehicle 106 has traveled up or down a ramp 702, which may be a ramp between two levels of the multi-level parking structure 700. In step 922, lower level maps 514 for each of the lower levels 704, 706, 708, 710 may be predicted based on the roof map 512. For example, the processor(s) 200 may predict lower level maps 514 for each of the lower levels 704, 706, 708, 710 by duplicating the roof map 512 and updating the lower level maps 514 using the sensor data 210.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-9D, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory in communication with the processor, the memory having instructions that, when executed by the processor, cause the processor to:
generate, based on an image of a roof of a multi-level parking structure, a roof map having at least one road segment and at least one parking space of the roof; and
predict, based on the roof map, a lower level map having at least one road segment and at least one parking space of a lower level of the parking structure.

2. The system of claim 1, wherein the instructions further cause the processor to predict the lower level map by duplicating the roof map.

3. The system of claim 2, wherein the instructions further cause the processor to:
receive, from at least one vehicle traveling through the multi-level parking structure, sensor data regarding a trajectory of the vehicle; and
update the lower level map based on the sensor data regarding the trajectory of the vehicle.

4. The system of claim 3, wherein the instructions further cause the processor to:
determine that at least one of a road segment and a parking space of the lower level is not used by the vehicle; and
update the lower level map to delete at least one of the road segment and the parking space.

5. The system of claim 3, wherein the instructions further cause the processor to:
determine a traveled vehicle road segment based on the sensor data regarding the trajectory of the vehicle, the traveled vehicle road segment being a road segment the vehicle has traveled; and
update the lower level map using the traveled vehicle road segment.

6. The system of claim 3, wherein the instructions further cause the processor to:
determine that the vehicle is parked at a location on the lower level that does not correspond to the at least one parking space of the roof map; and
update the lower level map to define a new parking space at the location at which the vehicle is parked.

7. The system of claim 3, wherein the instructions further cause the processor to:
determine a number of lower levels of multi-level parking structure based on the sensor data regarding the trajectory of the vehicle; and
predict, based on the roof map, lower level maps for each of the lower levels of the multi-level parking structure, each of the lower level maps having at least one road segment and at least one parking space.

8. A method comprising the steps of:
generating, based on an image of a roof of a multi-level parking structure, a roof map having at least one road segment and at least one parking space of the roof, and
predicting, based on the roof map, a lower level map having at least one road segment and at least one parking space of a lower level of the parking structure.

9. The method of claim 8, further comprising the step of predicting the lower level map by duplicating the roof map.

10. The method of claim 9, further comprising:
receiving, from at least one vehicle traveling through the multi-level parking structure, sensor data regarding a trajectory of the vehicle; and
updating the lower level map based on the sensor data regarding the trajectory of the vehicle.

11. The method of claim 10, further comprising:
determining that at least one of a road segment and a parking space of the lower level is not used by the vehicle; and
updating the lower level map to delete at least one of the road segment and the parking space.

12. The method of claim 10, further comprising:
determining a traveled vehicle road segment based on the sensor data regarding the trajectory of the vehicle, the traveled vehicle road segment being a road segment the vehicle has traveled; and
updating the lower level map using the traveled vehicle road segment.

13. The method of claim 10, further comprising:
determining that the vehicle is parked at a location on the lower level that does not correspond to the at least one parking space of the roof map; and
updating the lower level map to define a new parking space at the location at which the vehicle is parked.

14. The method of claim 10, further comprising:
determining a number of lower levels of the multi-level parking structure based on the sensor data regarding the trajectory of the vehicle; and
predicting, based on the roof map, lower level maps for each of the lower levels of the multi-level parking structure, each of the lower level maps having at least one road segment and at least one parking space.

15. A non-transitory computer-readable medium having instructions that, when executed by a processor, cause the processor to:
generate, based on an image of a roof of a multi-level parking structure, a roof map having at least one road segment and at least one parking space of the roof, and
predict, based on the roof map, a lower level map having at least one road segment and at least one parking space of a lower level of the parking structure.

16. The non-transitory computer-readable medium of claim 15, further having instructions that, when executed by the processor, cause the processor to predict the lower level map by duplicating the roof map.

17. The non-transitory computer-readable medium of claim 16, further having instructions that, when executed by the processor, cause the processor to:
receive, from at least one vehicle traveling through the multi-level parking structure, sensor data regarding a trajectory of the vehicle; and
update the lower level map based on the sensor data regarding the trajectory of the vehicle.

18. The non-transitory computer-readable medium of claim 17, further having instructions that, when executed by the processor, cause the processor to:
determine that at least one of a road segment and a parking space of the lower level is not used by the vehicle; and
update the lower level map to delete at least one of the road segment and the parking space.

19. The non-transitory computer-readable medium of claim 17, further having instructions that, when executed by the processor, cause the processor to:
determine a traveled vehicle road segment based on the sensor data regarding the trajectory of the vehicle, the traveled vehicle road segment being a road segment the vehicle has traveled; and
update the lower level map using the traveled vehicle road segment.

20. The non-transitory computer-readable medium of claim 17, further having instructions that, when executed by the processor, cause the processor to:
determine that the vehicle is parked at a location on the lower level that does not correspond to the at least one parking space of the lower level map; and
update the lower level map to define a new parking space at the location at which the vehicle is parked.
